(19) United States
(12) Patent Application Publication
(10) Pub. No.: US 2005/0054554 A1
(43) Pub. Date: Mar. 10, 2005

(54) Detergent additives

(75) Inventors: Georg Borchers, Bad Nauheim (DE); Alexander Lerch, Gelnhausen (DE); Gerd Reinhardt, Kelkheim (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 10/897,703

(22) Filed: Jul. 23, 2004

(30) Foreign Application Priority Data
Jul. 25, 2003 (DE) 10334045.9

(51) Int. Cl. C11D 3/00

(52) U.S. Cl. 510/528

(57) ABSTRACT

Detergent additives which are in granule form and are composed essentially of a) an active substance for detergents and b) an optical brightener.

The present invention relates to detergent additives composed essentially of an active substance with or without a granulating aid and comprising an optical brightener in order to improve the color quality.

Laundry detergents and other detergent cleaning products, such as washing powders, scouring salts or machine dishwashing detergents, for example, include various kinds of active substance, such as bleach activators, antiredeposition agents, soil release polymers, color fixatives, dye transfer inhibitors, complexing agents or enzymes, for example. These active substances are required to have a light appearance which is unchanged even in the presence of other detergent ingredients.

It has now been found that these active substances can be given a light appearance by adding an optical brightener. This mixture of active substance and optical brightener will be referred to below as detergent additive.

The invention provides detergent additives which are in granule form and are composed essentially of
a) an active substance for detergents and
b) an optical brightener.

Preferred active substances are bleach activators, antiredeposition agents, soil release polymers, color fixatives, dye transfer inhibitors, complexing agents or enzymes.

Bleach activators which can be used are compounds which under perhydrolysis conditions give rise to aliphatic peroxycarboxylic acids and/or substituted or unsubstituted perbenzoic acid. The bleaching result that can be achieved is governed by the nature and reactivity of the peroxycarboxylic acid formed, the structure of the bond to be subjected to perhydrolysis, and the water-solubility of the bleach activator.

Numerous substances are known from the prior art as bleach activators. Commonly they are reactive organic compounds containing an O-acyl or N-acyl group, which, promoted by the existing residual moisture, react with the bleach, such as sodium perborate, for example, while still in the washing powder mixture, provided the two components are in unprotected form.

Representative examples of bleach activators include N,N,N′,N′-tetraacetylethylenediamine (TAED), acylated triazine derivatives, especially 1,5-diacetyl-2,4-dioxohexahydro-1,3,5-triazine (DADHT), acylated glycoluriles, especially tetraacetylglycolurile (TAGU), N-acyl imides, especially N-nonanoylsuccinimide (NOSI), acylated phenol sulfonates, especially n-nonanoyl- or isononanoyloxybenzenesulfonate (n- or iso-NOBS), sodium 4-benzoyloxybenzenesulfonate (SBOBS), sodium trimethylhexanoyloxybenzenesulfonate (STHOBS), carboxylic anhydrides, especially phthalic anhydride, acylated polyhydric alcohols, especially triacetin, ethylene glycol diacetate, 2,5-diacetoxy-2,5-dihydrofuran and the enol esters known from DE 19616693, DE 19616767, and also acylated sorbitol and mannitol and the mixtures thereof described in EP 525239, acylated sugar derivatives, especially pentaacetyl glucose (PAG), pentaacetyl fructose, tetraacetyl xylose and octaacetyl lactose, and acetylated, unalkylated or N-alkylated/glucamine and gluconolactone, and/or lactams, N-benzoylcaprolactam for example. Additionally tetraacetylcyanic acid (TACA), di-N-acetyl-dimethylglyoxine (ADMG), 1-phenyl-3-acetylhydantoin (PAH), nonanoylcaprolactam phenylsulfonate ester (APES) and nitrilotriacetate (NTA) are used as bleach activators.

These abovementioned bleach activators have their maximum efficiency in the temperature range from 40° C. to 60° C.

Ammonium nitriles of the formula 1 form a particular class of cationic bleach activators which develop their activity even at temperatures below 40° C. Compounds of this kind and their use as bleach activators in bleaches are described in EP-A-0 303 520, EP-A-0 464 880, EP-A-0 458 396, EP-A-0 897 974 and EP-A-0 790 244. 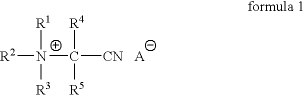
in which R¹, R² and R³ are identical or different and are linear or branched C₁-C₂₄ alkyl groups, C₂-C₂₄ alkenyl groups or C₁-C₄ alkoxy-C₁-C₄ alkyl groups, substituted or unsubstituted benzyl, or in which R¹ and R² together with the nitrogen atom to which they are attached form a ring having 4 to 6 carbon atoms which can be substituted by C₁-C₅ alkyl, C₁-C₅ alkoxy, C₁ to C₅ alkanoyl, phenyl, amino, ammonium, cyano, cyanoamino, chloro or bromo and in addition to the nitrogen atom may contain in lieu of carbon atoms one or two oxygen or nitrogen atoms, a group N-R⁶ or a group R³-N-R⁶, in which R⁶ is hydrogen, C₁ to C₅ alkyl, C₂ to C₅ alkenyl, C₂ to C₅ alkynyl, phenyl, C₇ to C₉ aralkyl, C₅ to C₇ cycloalkyl, C₁ to C₆ alkanoyl, cyanomethyl or cyano, R⁴ and R⁵ are hydrogen, C₁-C₄ alkyl, C₁-C₄ alkenyl, C₁-C₄ alkoxy-C₁-C₄ alkyl, phenyl or C₁-C₃ alkylphenyl, preferably hydrogen, methyl or phenyl, R⁴ in particular being hydrogen if R⁵ is not hydrogen, and A is an anion, such as chloride, bromide, iodide, fluoride, sulfate, hydrogen sulfate, carbonate, hydrogen carbonate, phosphate, mono- and di-hydrogen phosphate, pyrophosphate, metaphosphate, nitrate, methylsulfate, phosphonate, methylphosphonate, methanedisulfonate, methylsulfonate or ethanesulfonate.

Suitable antiredeposition agents include carboxymethylcellulose, methylcellulose, hydroxyalkylcellulose, methylhydroxyethylcellulose, methylhydroxypropylcellulose, methylcarboxymethylcellulose and polyvinylpyrrolidone.

Soil release polymers as active substances for the purposes of the present invention are preferably oligoesters comprising dicarboxylic acid units and diol units (glycol, alkylglycol and/or polyol units, especially polyalkylene polyglycol units). These oligoesters are preferably obtained by polycondensation of one or more aromatic dicarboxylic acids or esters thereof with diols, such as ethylene glycol, and/or with polyols. If desired these esters may also include polyethylene glycol, polypropylene glycol, sulfoisophthalic acid, sulfobenzoic acid, isethionic acid, C₁-C₄ alcohols, alkoxylated C₁-C₂₄ alcohols, alkoxylated C₆-C₁₈ alkylphenols and/or alkoxylated C₈-C₂₄ alkylamines as monomers. For the preparation of the oligoesters suitable dicarboxylic acid units include, for example, terephthalic acid, phthalic acid, isophthalic and also the monoalkyl and dialkyl esters with C₁-C₆ alcohols, such as dimethyl terephthalate, diethyl terephthalate and di-n-propyl terephthalate, but also oxalic acid, succinic acid, glutaric acid, adipic acid, fumaric acid, maleic acid, itaconic acid, and the monoalkyl and dialkyl esters of the carboxylic acids with C₁-C₆ alcohols, e.g., diethyl oxalate, diethyl succinate, diethyl glutarate, methyl adipate, diethyl adipate, di-n-butyl adipate, ethyl fumarate and dimethyl maleate, and also dicarboxylic anhydrides, such as maleic anhydride, phthalic anhydride or succinic anhydride. Preferred polyol units are polyethylene glycols having molar masses of from 500 to 5000, preferably from 1000 to 3000. Additionally, SRPs include as a further component water-soluble adducts of from 5 to 80 mol of at least one alkylene oxide with 1 mol of C₁-C₂₄ alcohols, C₆-C₁₈ alkylphenols or C₈-C₂₄ alkylamines. Preference is given to monomethyl ethers of polyethylene glycols.

Suitable alcohols which are alkoxylated are, for example, octyl alcohol, decyl alcohol, lauryl alcohol, myristyl alcohol or stearyl alcohol, but especially methanol, and also the alcohols of 8 to 24 carbon atoms that are obtainable by the Ziegler process or the corresponding oxo alcohols. Particular significance among the alkyl phenols is possessed by octylphenol, nonylphenol and dodecylphenol. Of the alkylamines that are suitable, use is made in particular of the C₁₂-C₁₈ monoalkylamines.

Examples of suitable polyols include pentaerythritol, trimethylolethane, trimethylolpropane, 1,2,3-hexanetriol, sorbitol, mannitol and glycerol.

Also particularly suitable are the polyesters known from EP 241 985 which in addition to oxyethylene groups and terephthalic acid units contain 1,2-propylene, 1,2-butylene and/or 3-methoxy-1,2-propylene groups and also glycerol units and are end group-capped with C₁-C₄ alkyl groups; the soil release polymers described in EP 253 567, having a molar mass of from 900 to 9000 g/mol and synthesized from ethylene terephthalate and polyethylene oxide terephthalate, the polyethylene glycol units having molar weights of from 300 to 3000 g/mol and the molar ratio of ethylene terephthalate to polyethylene oxide terephthalate being from 0.6 to 0.95; and the polyesters known from EP 272 033, which are at least partly end group-capped with C₁-C₄ alkyl or acyl radicals and contain polypropylene terephthalate and polyoxyethylene terephthalate units.

Likewise preferred are oligoesters synthesized from ethylene terephthalate and polyethylene oxide terephthalate, in which the polyethylene glycol units have molar weights of from 750 to 5000 g/mol and the molar ratio of ethylene terephthalate to polyethylene oxide terephthalate is from 50:50 to 90:10, the use of these oligoesters in laundry detergents being described in German patent DE 28 57 292, and also oligoesters having molar weights of from 15 000 to 50 000 g/mol and synthesized from ethylene terephthalate and polyethylene oxide terephthalate, the polyethylene glycol units having molar weights of from 1000 to 10 000 g/mol and the molar ratio of ethylene terephthalate to polyethylene oxide terephthalate being from 2:1 to 6:1, which according to DE 33 24 258 can be used in laundry detergents.

Also preferred are the oligoesters described in DE 19 644 034 of the formula 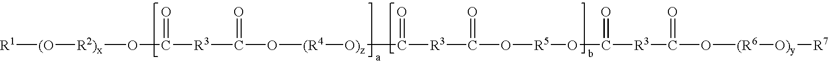
in which

R¹ and R⁷ are linear or branched C₁-C₁₈ alkyl,

R² and R⁶ are ethylene,

R³ is 1,4-phenylene,

R⁴ is ethylene,

R⁵ is ethylene, 1,2-propylene or random mixtures of both, of arbitrary composition,

x and y independently of one another are a number between 1 and 500,

z is a number between 10 and 140,

a is a number between 1 and 12,

b is a number between 7 and 40,

a+b being at least 11.

Preferably, independently of one another,

R¹ and R⁷ are linear or branched C₁-C₄ alkyl,

x and y are a number between 3 and 45,

z is a number between 18 and 70,

a is a number between 2 and 5,

b is a number between 8 and 12,

a+b being a number between 12 and 18 or between 25 and 35. The oligoesters described in DE 19 644 034 are obtained from dimethyl terephthalate, ethylene glycol and/or propylene glycol, polyethylene glycol and C₁ to C₁₈-alkylpolyethylene glycol, initially by transesterification at temperatures from 160 to about 220° C., with addition of a catalyst, and separation of the methanol by distillation under atmospheric pressure, and subsequently by distillative separation of the excess glycols at temperatures from 160 to about 240° C.

The invention includes as active substances color fixatives, examples being those obtained by reacting diethylenetriamine, dicyandiamide and amidosulfuric acid, amines with epichlorohydrin, for example dimethylaminopropylamine and epichlorohydrin or dimethylamine and epichlorohydrin or dicyandiamide, formaldehyde and ammonium chloride, or dicyandiamide, ethylenediamine and formaldehyde or cyanamide with amines and formaldehyde or polyamines with cyanamides and amidosulfuric acid or cyanamides with aldehydes and ammonium salts, but also polyamine N-oxides such as poly(4-vinylpyridine N-oxide), e.g., Chromabond S-400, ISP; polyvinylpyrrolidone, e.g., Sokalan HP 50, BASF, and copolymers of N-vinylpyrrolidone with N-vinylimidazole and if desired with other monomers.

Also suitable are dye transfer inhibitors, examples being polyamine N-oxides such as poly(4-vinylpyridine N-oxide), e.g., Chromabond S-400, ISP; polyvinylpyrrolidone, e.g., Sokalan HP 50, BASF, and copolymers of N-vinylpyrrolidone with N-vinylimidazole and if desired with other monomers.

In accordance with the invention it is likewise possible to produce complexing agents with a light appearance which are in powder or granule form, examples being amino carboxylates, such as ethylenediaminetetraacetate, N-hydroxyethylethylenediaminetriacetate, nitrilotriacetate, ethylenediaminetetrapropionate, triethylenetetraminehexaacetate, diethylenetriaminepentaacetate, cyclohexanediaminetetraacetate, phosphonates, such as azacycloheptanediphosphonate, Na salt, pyrophosphates, etidronic acid (1-hydroxyethylidene-1,1-diphosphonic acid), 1-hydroxyethane-1,1-diphosphonic acid (acetophosphonic acid) and the salts thereof, amino phosphonates, such as ethylenediaminetetrakis(methylenephosphonate), diethylenetriaminepentakis (methylenephosphonate), aminetrimethylenephosphonic acid, cyclodextrins, and also polyfunctionally substituted aromatic complexing agents, such as dihydroxydisulfobenzene and also ethylenediaminedisuccinates.

In accordance with the invention it is also possible to lighten enzyme granules. Suitable enzymes include those from the class of the proteases, lipases, amylases, pullinases, cutinases and cellulases, peroxidases and mixtures thereof. Available proteases include BLAP®, Opticlean®, Maxacal®, Maxapem®, Esperase®, Savinase®, Purafect®, OxP and/or Duraxym®, available amylases include Termamyl®, Amylase-LT®, Maxamyl®, Duramyl® and/or Pruafect® OxAm, available lipases include Lipolase®, Lipomax®, Lumafast® and/or Lipozym®.

The enzymes can be adsorbed on carrier substances and/or embedded in coating substances.

Suitable optical brighteners include all known optical brighteners, as described in “The Production and Application of Fluorescent Brightening Agents”, M. Zahradnik, John Wiley & Sons, New York (1982) and in Ullmann's Encyclopedia of Industrial Chemistry, “Optical Brighteners”, A. E. Siegrist, Eckhardt, J. Kaschig, E. Schmidt, Vol. A18, VCH Publishers, New York (1991), pp. 153-176 CC.

Optical brighteners which can be used include cyclic hydrocarbons such as distyrylbenzenes, distyrylbiphenyls, diphenylstilbenes, triazinylaminostilbenes, stilbenyl-2H-triazoles, such as stilbenyl-2H-naphtho[1,2-d]triazoles and bis(1,2,3-triazol-2-yl)stilbenes, benzoxazoles, such as stilbenylbenzoxazole and bis(benzoxazole), furans, benzofurans and benzimidazoles, such as bis(benzo[b]furan-2-yl)biphenyl and cationic benzimidazoles, 1,3-diphenyl-2-pyrazoline, coumarin, naphthalimides, 1,3,5-2-yl derivatives, methine cyanine and dibenzothiophene 5,5-oxide.

Preference is given to anionic optical brighteners, especially sulfonated compounds.

Additionally suitable are triazinylaminostilbenes, distyrylbiphenyls and mixtures thereof, 2-(4-styrylphenyl)-2H-naphtho[1,2-d]triazole, 4,4′-bis(1,2,3-triazol-2-yl)stilbene, aminocoumarin, 4-methyl-7-ethylaminocoumarin, 1,2-bis(benzimidazol-2-yl)ethylene, 1,3-diphenylpyrazoline, 2,5-bis(benzoxazol-2-yl)thiophene, 2-strylnaphtho[1,2-d]oxazole, 2-(4-styryl-3-sulfophenyl)-2H-naphtho[1,2-d]triazole and 2-(stilben-4-yl)-2H-naphtho[1,2-d]triazole.

The bleach activator granules of the invention contain optical brighteners in amounts of from 0.001 % to 2% by weight, preferably from 0.002% to 0.8% by weight, more preferably from 0.003% to 0.4% by weight.

The additives of the invention are prepared by mixing one or more active substances with one or more optical brighteners, it being also possible if desired to add customary granulating aids, and granulating this mixture subsequently by conventional methods. The active substances can be used in solid form, in the form of a melt, in suspension or in dissolved form. The same applies to the granulating aids. The optical brighteners can be added as powder, as a suspension, but preferably in dissolved form.

When preparing a liquids mixture comprising the optical brightener it may prove advantageous to filter off undissolved brightener fractions prior to further processing. Where the optical brightener is added in powder form an improvement in the processing and/or in the attainable product quality may be brought about by targeted pretreatment of the brightener, e.g., by grinding.

The individual components can be mixed in customary batch or continuous mixing apparatus, generally equipped with rotating mixing elements: for example, in a plowshare mixer for solids mixtures or in a stirred tank for liquids mixtures. Depending on the efficiency of the mixing apparatus the mixing times for a homogeneous mixture are generally between 30 seconds and 5 minutes.

Different possibilities for further processing arise in dependence on the aggregate state of the mixture of active substance, optical brightener and, if used, granulating aid.

A pulverulent active substance can be wetted with an aqueous solution of a granulating aid or with a solution of an optical brightener at room temperature or at elevated temperatures and subsequently granulated and dried. A common operation that may be conceived of in this context is that of mixer agglomeration, for which, for example, plowshare, annular bed or Schugi mixers may be employed. Predominantly the mixers are operated continuously, although for certain types of mixer batch operation is also conceivable.

An alternative procedure in accordance with a second version is to spray-apply granulating aid and/or optical brightener and/or active detergent substance to a solid substance: for example, to a solid bleach activator or a suitable solid carrier (silica). Depending on the amount of liquid applied it may be necessary to carry out subsequent drying, e.g., in a fluid-bed dryer. Spray application may take place in a suitable mixer with subsequent drying or else directly in a dryer.

Another mode of preparation is to dry-mix all of the components (active substance, optical brightener and, if used, granulating aid) and to granulate the mixture. A common operation in this context is that of dry compacting on roll compactors with subsequent size reduction. In one mode of operation it is possible to spray a certain quantity of liquid onto the dry powder mixture prior to compression, in order to improve the compacting properties. In this case it may prove advantageous if the optical brightener is dissolved in the auxiliary liquid.

In another preparation process, all of the components are mixed with one another and through the addition of a plasticizer, such as polyethylene glycol, for example, a plastically deformable mass is produced which is subsequently extruded through die bores. The extrudates produced in this way can be shortened to the desired granule lengths by using strippers, cutters or in spheronizers. Examples of common apparatus for this operation include annular edge-runner presses, shallow-die presses and extruders. The plasticizer used is in very many cases water or else a meltable substance. Depending on the chosen plasticizer it may be necessary to dry or cool the granules following granulation.

In another preferred embodiment the mixture of all the components is in the form of a solution or suspension which is converted to a dry form by means of a spraying operation. Where the spray liquid is processed by spray drying, in a nozzle tower or disc tower in cocurrent or countercurrent mode, for example, a fine powder can be produced. In the case of fluidized-bed granulation the spray liquid is processed to granules in a fluid bed consisting of a carrier material and/or the product mixture. Common fluidized-bed apparatus is of circular or rectangular design and can be operated batchwise or continuously.

Where the mixture of the components is in the form of a melt, it is possible in addition to the aforementioned spraying operations with the use of a cooling gas to carry out solidification on cooling belts or cooling pans. The melt can be applied in the form of a layer, in the form of strips or by means of a pelletizing technique. After the melt has solidified, further reduction in size to the desired particle size may be necessary. The product melts can also be processed in mixers, in which case the melt is applied, possibly by spraying, to a suitable carrier or to a mixture of different solids and is granulated by a method similar to wet granulation. In this case, rather than the subsequent drying, cooling is required.

The granules obtained in accordance with the invention are directly suitable for use in detergents. In another preferred form of use, however, they can be provided by conventional methods with a coating. For that purpose the cogranulated product, comprising active substances and optical brightener, is coated in a further step with a film former, thereby allowing the properties of the product to be influenced substantially. It may prove advantageous if the optical brightener is also present in the coating. The total fraction of optical brightener present in the final granules may be divided in any desired way between core and coating.

Suitable coating agents include all film formers, such as waxes, silicones, fatty acids, fatty alcohols, soaps, anionic surfactants, nonionic surfactants, cationic surfactants, anionic and cationic polymers, polyethylene glycols and other polyalkylene glycols.

Preference is given to using coating substances having a melting point of 30-100° C. Examples thereof and also a process for application are described in EP-A-0 835 926. The coating materials are generally applied by spraying the melted coating materials or a solution of the coating materials in a solvent. The coating material can be applied in amounts of from 0 to 30% by weight, preferably from 5 to 15% by weight, based on the total weight, to the granule core of the invention.

In one preferred embodiment anionic or nonionic surfactants or polyalkylene glycols can be used as granulating aids. Preferred anionic surfactants are alkali metal salts, ammonium salts, amine salts and salts of amino alcohols derived from the following compounds: alkyl sulfates, alkyl ether sulfates, alkylamide sulfates and alkylamide ether sulfates, alkylaryl polyether sulfates, monoglyceride sulfates, alkylsulfonates, alkylamidosulfonates, alkylarylsulfonates, α-olefinsulfonates, alkylsulfosuccinates, alkyl ether sulfosuccinates, alkylamidosulfosuccinates, alkylsulfoacetates, alkylpolyglycerol-carboxylates, alkyl phosphates, alkyl ether phosphates, alkylsarcosinates, alkylpolypeptidates, alkylamidopolypeptidates, alkylisethionates, alkyltaurates, alkylpolyglycol ether carboxylic acids or fatty acids, such as oleic acid, ricinoleic acid, palmitic acid, stearic acid, salt of copra oil acid or hydrogenated salts of copra oil acid. The alkyl radical of all these compounds contains normally 8-32, preferably 8-22 carbon atoms. Particular preference is given to linear straight-chain alkylbenzenesulfonates, especially those having a C₈-C₂₀ alkyl group, more preferably having a C₁₁-C₁₃ alkyl group.

Preferred nonionic surfactants are polyethoxylated, polypropoxylated or polyglycerolated ethers of fatty alcohols, polyethoxylated, polypropoxylated and polyglycerolated fatty acid esters, polyethyloxylated esters of fatty acids and of sorbitol, and polyethoxylated or polyglycerolated fatty amides.

Suitable polyalkylene glycols include polyethylene glycols, 1,2-polypropylene glycols and modified polyethylene glycols and polypropylene glycols. The modified polyalkylene glycols include in particular sulfates and/or disulfates of polyethylene glycols or of polypropylene glycols having a relative molecular mass of between 600 and 12 000 and in particular between 1000 and 4000. Another group is made up of mono- and/or disuccinates of the polyalkylene glycols which in turn have relative molecular masses of between 600 and 6000, preferably between 1000 and 4000. Also included are ethoxylated derivatives such as trimethylolpropane with from 5 to 30 EO.

The polyethylene glycols used with preference may have a linear or branched structure, particular preference being given to linear polyethylene glycols. The particularly preferred polyethylene glycols include those having relative molecular masses of between 2000 and 12 000, advantageously around 4000, it being possible to use polyethylene glycols having relative molecular masses of below 3500 and above 5000 in particular in combination with polyethylene glycols having a relative molecular mass of around 4000, and combinations of this kind advantageously contain more than 50% by weight, based on the total amount of polyethylene glycols, of polyethylene glycols having a relative molecular mass of between 3500 and 5000.

The modified polyethylene glycols also include singly or multiply endgroup-capped polyethylene glycols, the endgroups preferably being C₁-C₁₂ alkyl chains, preferably C₁-C₆, which may be linear or branched. Singly endgroup-capped polyethylene glycol derivatives may also be of the formula Cₓ(EO)_{y}(PO)_{z}, where Cₓ can be an alkyl chain having a C chain length of from 1 to 20, y can be from 50 to 500 and z can be from 0 to 20. Also suitable are low molecular mass polyvinylpyrrolidones and derivatives thereof having relative molecular masses of up to a maximum of 30 000. Preference is given here to relative molecular mass ranges between 3000 and 30 000. Polyvinyl alcohols are preferably used in combination with polyethylene glycols.

Particularly preferred for use in the process of the invention is PEG 4000.

In order to improve the plasticizing and lubricity properties but also the abrasion resistance of the additive granules it is possible in addition to add one or more components which are liquid at room temperature or which under the processing conditions are in the form of a melt, examples being linear or branched fatty acids or ethoxylated fatty acids containing from 2 to 100 EO.

The above-described mixture of all the components may further comprise small amounts of a solvent, preferably less than 15% by weight, more preferably less than 10% by weight, very preferably less than 7% by weight.

Further suitable additions are substances which influence the pH during storage and application. These include organic carboxylic acids or salts thereof, such as citric acid in anhydrous or hydrated form, glycolic acid, succinic acid, maleic acid or lactic acid. Also suitable are additions which influence the bleaching capacity, such as complexing agents and transition metal complexes, e.g., iron-, cobalt- and/or manganese-containing metal complexes as described in EP-A-0 458 397 and EP-A-0 458 398.

Examples below are intended to illustrate the invention without restricting it thereto.

### EXAMPLE 1

Preparation of a Cogranulated Product Comprising the Bleach Activators Ammonium Nitrile and TAED

1.) Preparation of a Spray Slurry:

In the first step 347.2 g of a 40% strength aqueous solution of Na cumenesulfonate (NCS) were mixed at room temperature with 185.2 g of a 45% strength aqueous solution of Sokalan CP45. Gradually thereafter 284.6 g of a 59% strength aqueous solution of trimethylammonium nitrile methosulfate (Peractive NQL) were added, the active content of the solution being approximately 49%. In order to prevent partial, temporary precipitation of a mixed salt of Peractive NQL and NCS during the addition of the ammonium nitrile solution, the mixing solution was homogenized intensively using an Ultra-Turrax during the addition. 0.265 g of the optical brightener Tinopal CBS-X was introduced into and dissolved in the aqueous spray solution.

2.) Fluidized-Bed Granulation:

For laboratory experiments a batch-operating laboratory fluidized bed of type GPCG 1.1 from the company Glatt with a flow inlet diameter of D=150 mm was employed, the spraying nozzle spraying onto the fluidized bed from above.

The quantity of TAED required to complete the desired formula, an amount of 139 g, was introduced in the laboratory fluidized bed together with 495.7 g of fluidized bed material from previous experiments (granules and comminuted oversize). The material was fluidized with a gas volume flow of about 22-31 m³/h, the gas entry temperature being about 90-95° C. Over a period of 42 minutes 820 g of the spray slurry was sprayed into the fluidized bed, with a metering output of 19-20 g/min. A temperature of about 65-72° C. became established in the fluidized bed.

The granules produced in this way were sieved off to the target particle size of 630-1180 μm and then subjected to color measurement. The comparison product available was a fluidized bed granule product of the same composition but without the addition of optical brighteners.

The lightness L and also the color shift values a and b were determined using a LabScan XE LSXE and a calorimeter with HunterLab DP-9000 processor, UV Control (HunterLab). The parameter L is a measure of the whiteness of the sample, the sample appearing lighter or whiter the greater the L value. The a value describes shifts on the red(+a)-green(−a) scale, while the b value describes shifts on the yellow(+b)-blue(−b) scale.

| | |
|---|---|
| Optical brightener | Tinopal CBS-X |

| | | |
|---|---|---|
| Amount of optical brightener added (g) | 0 | 0.265 |
| L | 84.36 | 85.05 |
| A | −0.78 | −0.05 |
| B | 8.78 | 2.74 |

As the color values of the untreated sample show, the granules have a visible yellow tinge (+b value), which in a light or white environment is clearly visible and unaesthetic. With the addition of the brightener, on the other hand, the yellow tinge can be reduced significantly and at the same time a slight improvement can be achieved in the whiteness (L value).

### EXAMPLE 2

Laundrycare Additive

1.) Preparation of the Granulating Liquid

In the first step 60 g of PEG 6000 and 20 g of Genapol UD 050 were weighed out and 370 g of deionized water were added. The mixture was mixed until a homogeneous liquid had formed. 0.2 g of the optical brightener Tinopal CBS-X was dissolved in the granulating liquid.

2.) Granulation in a Mixer

The mixing vessel was charged with 320 g of the pulverulent care additive Texcare CFR 100 (methylhydroxyethylcellulose) and thorough mixing was carried out at maximum mixer speed. The granulating liquid was introduced over a period of 45 seconds into the moving bed of powder and was mixed with the powder. The mixing operation was continued for a further 105 seconds, in the course of which granules began to form. At the end of the total batch time of 150 seconds the moist product mixture was withdrawn and transferred directly to a fluidized-bed dryer. The granules were dried over a period of 15 minutes and then the target fraction 800-1600 μm was extracted by sieving.

For comparison, granules were produced in a similar way but without the addition of an optical brightener and were subjected to color measurement in parallel with the first sample.

The lightness L and also the color shift values a and b were determined using a LabScan XE LSXE and a calorimeter with HunterLab DP-9000 processor, UV Control (HunterLab). The parameter L is a measure of the whiteness of the sample, the sample appearing lighter or whiter the greater the L value. The a value describes shifts on the red(+a)-green(−a) scale, while the b value describes shifts on the yellow(+b)-blue(−b) scale.

| | |
|---|---|
| | Tinopal |
| Optical brightener | CBS-X |

| | | |
|---|---|---|
| Amount of optical brightener added (g) | 0 | 0.2 |
| L | 82.18 | 84.56 |
| a | −2.05 | 1.68 |
| b | 7.35 | −2.24 |

A comparison of the color values for the two granule samples shows that with the addition of the optical brightener there was firstly a visible improvement achieved in the whiteness (increase in the L value by about 2.5 units). Additionally a unaesthetic yellowish tinge in the product is reduced significantly by the optical brightener (b shifts towards smaller values).

### EXAMPLE 3

Preparation of Granules Containing the Bleach Activator NOBS

A product quantity of about 5 g of Tinopal CBS-X was ground in a standard commercial laboratory mill (Retsch) for 1 minute, so that the optical brightener was in the form of a fine powder having an average particle size of about 35-40 μm. 1.98 g (0.28%) of the ground brightener were mixed homogeneously in a plowshare mixer from Lödige with 594.1 g (85.44% by weight) of nonanoyloxybenzenesulfonate, Na (NOBS) and 29.6 g (4.26% by weight) of linear C₁₁-C₁₃-alkylbenzenesulfonate, Na salt, and the mixture was heated to 63-64° C. 50.0 g (7.19% by weight) of polyethylene glycol 4000 were heated to 80° C., and thereupon melted, and were then mixed in a stirring vessel with 19.7 g (2.83% by weight) of nonanoic acid. The liquids mixture was then metered at a temperature of 80° C. into the NOBS/LAS mixture in the plowshare mixture at a rotary speed of 135 min⁻¹ over a period of 30 seconds and the components were mixed homogeneously for a further 30 seconds.

The pasty mixture was transferred at a temperature of 65° C. to 71° C. to a single-screw dome extruder from Fuji-Paudal whose die has a bore diameter of 0.7 mm and the mixture was extruded at a screw speed of 45 per minute with a throughput of about 210 g/min. Subsequently the extrudate was brought to particle sizes of d=0.7 mm and I=1.4 mm in the batch spheronizer from Hosokawa-Bepex, having a diameter of 0.3 m, with a rotary speed of 994 per minute, a peripheral speed of 15.6 m/sec and a residence time of 30 seconds, at a temperature of from 65 to 69° C.

For the purpose of comparison, granules were produced in a similar way but without the use of an optical brightener and were subjected to color measurement in parallel with the first sample.

The lightness L and also the color shift values a and b were determined using a LabScan XE LSXE and a calorimeter with HunterLab DP-9000 processor, UV Control (HunterLab). The parameter L is a measure of the whiteness of the sample, the sample appearing lighter or whiter the greater the L value. The a value describes shifts on the red(+a)-green(−a) scale, while the b value describes shifts on the yellow(+b)-blue(−b) scale.

| | |
|---|---|
| | Tinopal |
| Optical brightener | CBS-X |

| | | |
|---|---|---|
| Amount of optical brightener added (g) | 0 | 1.98 |
| L | 80.3 | 82.10 |
| a | −0.78 | 1.90 |
| b | 8.78 | 0.4 |

A comparison of the color values for the two granule samples shows that with the addition of the optical brightener there was firstly a visible improvement achieved in the whiteness (increase in the L value by about 2 units). Additionally an unaesthetic yellowish tinge in the product is reduced significantly by the optical brightener (b shifts toward smaller values).

Chemical designation of the commercial products employed

| | |
|---|---|
| TINOPAL ® CBS-X (Ciba Geigy): | 4,4′-bis(2-sulfostyryl)biphenyl, |
| | sodium salt |
| Peractive NQL (Clariant GmbH): | trimethylammonium nitrile |
| | methosulfate, |
| | aqueous solution |
| TAED (Clariant GmbH) | Tetraacetylethylenediamine |
| Genapol ® UD 50 (Clariant GmbH) | C₁₁ oxo alcohol polyglycol |
| | ether |
| PEG 4000: | polyethylene glycol, MW ?-? |
| | g/mol |
| PEG 6000: | polyethylene glycol, MW |
| | 5600-6600 g/mol |
| Sokalan ® CP 45 (BASF): | copolymer based on maleic |
| | acid, acrylic acid, sodium salt |

The granules obtained in accordance with the invention are directly suitable for use in detergents. They can be provided, if desired, with a coating.

Further possible additions are substances which react in the wash liquor with the peroxycarboxylic acid released from the activator to form reactive intermediates, such as dioxiranes or oxaziridines, and in that way are able to increase the reactivity. Corresponding compounds are ketones and sulfonimines in accordance with U.S. Pat. No. 3,822,114 and EP-A-0 446 982.

The amount of the added substance is guided in particular by its type. Thus acidifying additions and organic catalysts for enhancing the performance of the peracid are added in amounts of from 0 to 20% by weight, in particular in amounts of from 1 to 10% by weight, based on the overall weight, whereas metal complexes are added in concentrations in the ppm range.

The granules obtained are distinguished by very good color quality, abrasion resistance and storage stability in pulverulent laundry detergent, cleaning product and disinfectant formulations. They are ideal for use in heavy-duty laundry detergents, scouring salts, machine dishwashing detergents, general-purpose cleaners in powder form, and denture cleansers.

In these formulations the granules of the invention are employed generally in combination with a hydrogen peroxide source. Examples of such sources include perborate monohydrate, perborate tetrahydrate, percarbonates and also adducts of hydrogen peroxide with urea or with amine oxides. In addition, the formulation may include further, prior art detergent ingredients, such as organic and inorganic builders and cobuilders, surfactants, enzymes, brighteners and perfume.

1. A detergent additive which is in granule form and is composed essentially of
a) an active substance for detergents and
b) an optical brightener.

2. The additive as claimed in claim 1, further comprising a granulating aid.

3. The additive as claimed in claim 1, wherein the active substance for detergents is selected from the group consisting of a bleach activator, bleaching catalyst, antiredeposition agent, soil release polymer, color fixative, dye transfer inhibitor, complexing agent, enzyme and mixtures thereof.

4. A process for preparing an additive as claimed in claim 1, which comprises mixing the active substance and the optical brightener and optionally, the granulating aid and subsequently granulating said mixture.

5. A detergent additive in granule form consisting essentially of
a) an active substance for detergents selected from the group consisting of a bleach activator, a bleaching catalyst, an antiredeposition agent, a soil release polymer, a color fixative, a dye transfer inhibitor, a complexing agent, an enzyme and mixtures thereof,
b) an optical brightener, and
c) optionally, a granulating aid.

6. A process for producing a detergent additive granule, said process comprising
a) mixing a active substance selected from the group consisting of a bleach activator, a bleaching catalyst, an antiredeposition agent, a soil release polymer, a color fixative, a dye transfer inhibitor, a complexing agent, an enzyme and mixtures thereof, and an optical brightener to provide a mixture, and
b) granulating said mixture to provide the detergent additive granule. 7. The process of claim 6, further comprising adding to the mixture a granulating aid prior to said granulating step b).
